(19) United States
(12) Patent Application Publication
(10) Pub. No.: US 2008/0290113 A1
(43) Pub. Date: Nov. 27, 2008

(54) Actuator cap for a spray device

(76) Inventors: Thomas A. Helf, New Berlin, WI (US); Edward L. Paas, Los Altos, CA (US)

Correspondence Address: S.C. JOHNSON & SON, INC., 1525 HOWE STREET, RACINE, WI, 53403-2236, US

(21) Appl. No.: 11/805,976

(22) Filed: May 25, 2007

(51) Int. Cl. B67D 5/08; B67D 3/00; G04C 23/42

(52) U.S. Cl. 222/52; 16/404; 222/649; 222/504

(57) ABSTRACT

An actuator cap for a dispenser includes a housing having first and second ends. The first end is adapted to be retained on an aerosol container having a valve stem. A conduit is provided having an inlet adapted to receive the valve stem of the container and to hold the valve stem in an actuated position to open a valve assembly within the container. A solenoid valve is in fluid communication with the conduit and a discharge orifice. The solenoid valve is transitioned from a closed state to an open state by a signal generated by a controller to provide a fluid path between the conduit and the discharge orifice. The controller is adapted to generate the signal in response to the manual depression of a trigger retained on the housing by a living hinge.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Background

The present disclosure relates generally to discharging a fluid from a spray device, and more particularly, to an actuator for automatically and manually discharging a fluid from a pressurized aerosol container.

2. Description of the Background of the Invention

Discharge devices for automatically dispensing pressurized fluids from aerosol containers are typically provided with an actuator mechanism for engaging a nozzle of the aerosol container. Some actuator mechanisms retain the nozzle of the aerosol container in an open position and regulate the emission of fluid through a separate valve in the device. In several of these devices, the valve comprises a solenoid valve that is electronically controlled to open and close a fluid path to dispense the contents of the aerosol container. However, many of these devices suffer from the drawback of not allowing the solenoid valve to be opened in response to a signal generated automatically by a timer or sensor and a signal generated by the manual actuation of a trigger by a user. Further, those devices that include a manual switch do not include an easily actuable trigger mounted on a housing of the device that allows for the device to be used in a stand-alone fashion or in the hand of a user.

One example of such a device includes a housing with an inlet provided in a bottom wall thereof. The inlet is adapted to receive a vertically operative valve stem of a container and hold the valve stem in a depressed and open position to allow fluid discharge from the container. A solenoid valve having a spring biased plug is disposed adjacent the bottom wall. When the device is activated, the plug is moved laterally to provide a passage for the fluid to pass through an opening in a valve seat, into an outlet channel, and out of the housing through an outlet opening.

In a different example, a discharge device includes a housing adapted to hold an aerosol container. A solenoid valve is in communication with a discharge end of the container, which maintains a discharge valve of the container in an open position. A controller is electrically coupled to the solenoid valve to cause the periodic discharge of fluid through a discharge outlet thereof, which is aligned with a discharge orifice of the housing. A manual switch is also provided, which is electrically coupled to the controller to allow for the manual activation of the solenoid valve.

### SUMMARY OF THE INVENTION

In one embodiment, an actuator cap for a dispenser includes a housing having first and second ends, wherein the first end is adapted to be retained on an aerosol container having a valve stem. A conduit is provided having an inlet adapted to receive the valve stem of the container and to hold the valve stem in an actuated position to open a valve assembly within the container. A solenoid valve is in fluid communication with the conduit and a discharge orifice, wherein the solenoid valve is transitioned from a closed state to an open state by a signal generated by a controller to provide a fluid path between the conduit and the discharge orifice. The controller is adapted to generate the signal in response to the manual depression of a trigger retained on the housing by a living hinge.

In a different embodiment, an overcap for a dispenser includes a housing having a bottom end and a top end, wherein the bottom end is retained on an aerosol container having a valve stem. A conduit is provided having first and second ends, wherein portions of the conduit defining the second end hold the valve stem in a depressed and open position, and wherein the second end is in fluid communication with a discharge orifice of the valve stem. A solenoid valve is in fluid communication with the first end of the conduit and a discharge orifice, wherein the solenoid valve is transitioned from a closed state to an open state by a signal generated by a controller. The controller is adapted to generate the signal in response to the manual depression of a flange retained on the housing by a living hinge.

In another embodiment, a retention mechanism for a dispenser includes an annular bracket having a plurality of interiorly extending flanges adapted to hold the bracket on an aerosol container having a valve stem. The bracket is further adapted to releasably engage an overcap and align an actuation mechanism within an interior of the overcap with the valve stem.

Other aspects and advantages of the present invention will become apparent upon consideration of the following detailed description.

### BRIEF DESCRIPTION OF THE DRAWINGS

FIG. 1 is an isometric view of a front side, a left side, and a top side of a first embodiment of an overcap;

FIG. 2 is a front isometric view of the overcap of FIG. 1;

FIG. 3 is a rear elevational view of the overcap of FIG. 1;

FIG. 4 is a left side elevational view of the overcap of FIG. 1;

FIG. 5 is a right side elevational view of the overcap of FIG. 1;

FIG. 6 is a top plan view of the overcap of FIG. 1;

FIG. 7 is a bottom elevational view of the overcap of FIG. 1;

FIG. 8 is a rear exploded isometric view of a body, a platform, and a top end of the overcap of FIG. 1;

FIG. 9 is a front exploded isometric view of a body, a platform, and a top end of the overcap of FIG. 1;

FIG. 10 is an enlarged isometric view of the platform of FIGS. 8 and 9;

FIG. 11 is a partial sectional view taken along section 11-11 of the overcap of FIG. 1, which includes one embodiment of a bracket for mounting the overcap on a container;

FIG. 12 is an isometric view illustrating the overcap of FIG. 1 on a container;

FIG. 13 is an isometric view of the bracket of FIG. 11 mounted on a container;

FIG. 14 is an isometric view of the bracket of FIG. 13 removed from the container;

FIG. 15 is a front elevational view of the bracket of FIG. 14;

FIG. 16 is a top plan view of the bracket of FIG. 14;

FIG. 17 is a bottom elevational view of the bracket of FIG. 14;

FIG. 18 illustrates another isometric view of an overcap similar to the one depicted in FIG. 12, which includes an A.C. connector;

FIG. 19 is an isometric view of the overcap of FIG. 1 illustrating several triggers on various portions of the overcap;

FIG. 20 is a timing diagram illustrating the operation of the overcap of FIGS. 1-11 according to a first operational sequence;

FIG. 21 is an isometric view of another embodiment of the overcap of FIG. 1 with portions of the overcap removed to show a frangible tab affixed to a lug on an inside portion of the overcap;

FIG. 22 is an isometric view of the bracket of FIG. 14 in combination with the lug of the overcap of FIG. 21, wherein the overcap has been removed for purposes of clarity;

FIG. 23 is an isometric view of the bracket of FIG. 22 showing the lug in a second position after the frangible tab has been broken;

FIG. 24 is an isometric view of the bracket of FIG. 22 illustrating the lug in a third position;

FIG. 25 is an isometric view of the bracket of FIG. 22 illustrating the lug in a fourth position; and

FIG. 26 is a schematic front elevational, partial sectional view of another embodiment of an overcap.

### DETAILED DESCRIPTION OF THE DRAWINGS

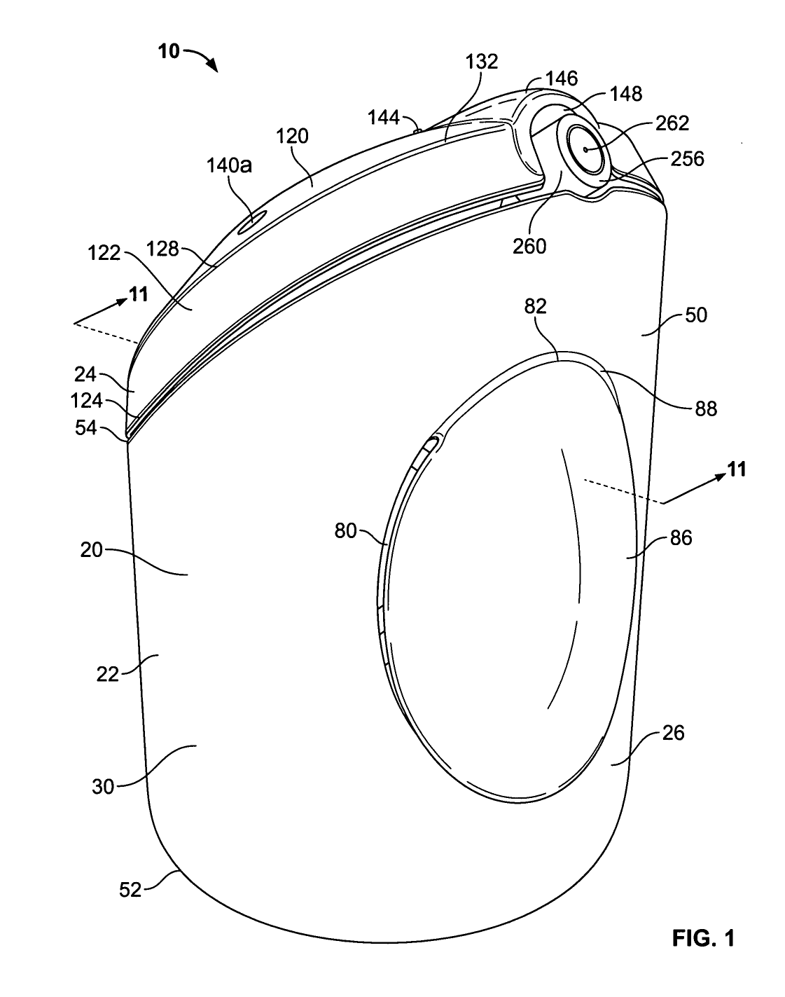

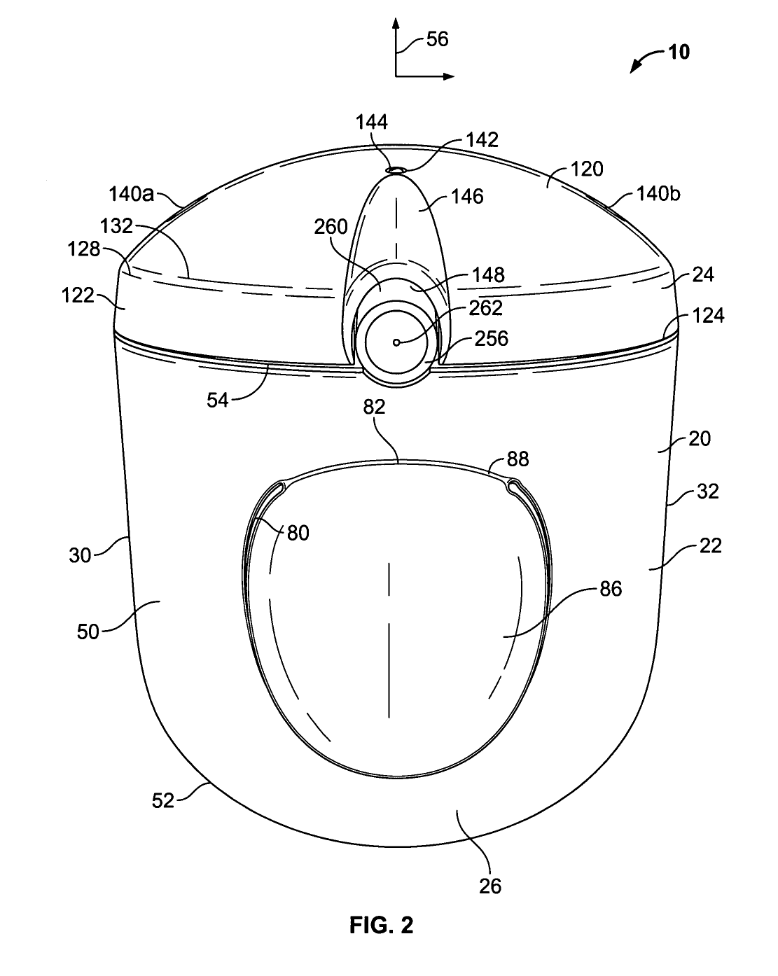

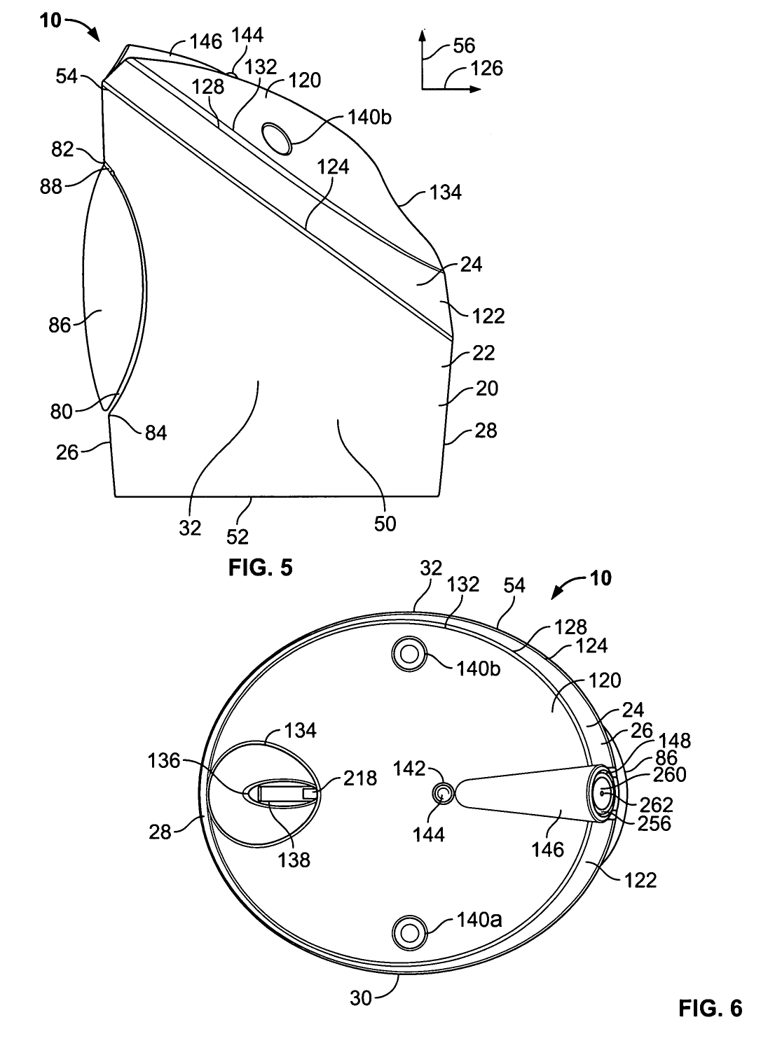

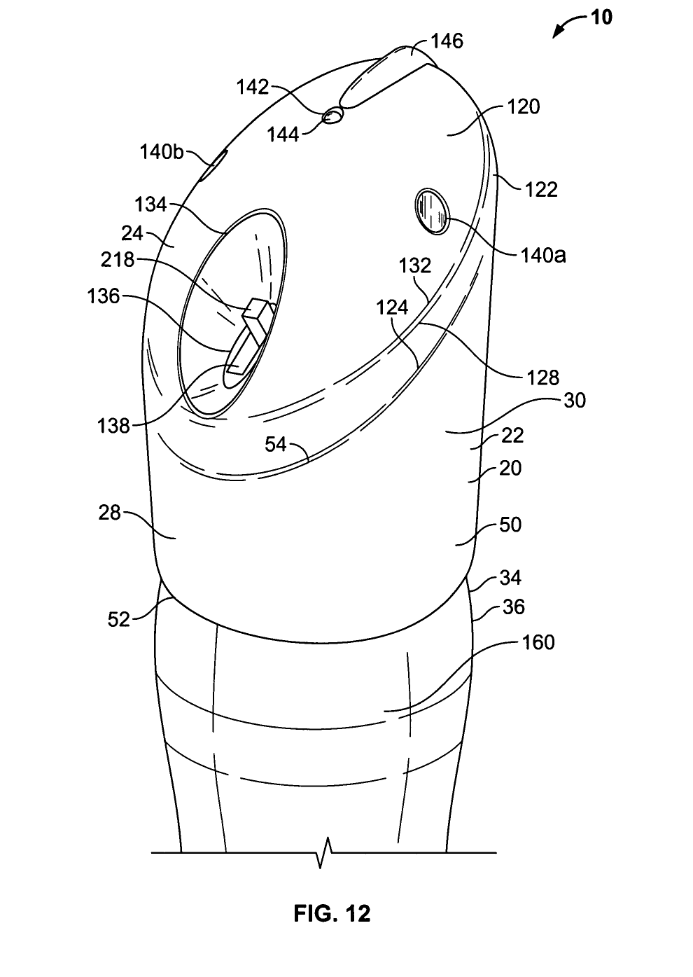

FIGS. 1-11 depict an actuator overcap 10 having a housing 20. The housing 20 includes a body portion 22 and a cap portion 24 disposed on a top end thereof. The housing 20 is also generally delineated by a front side 26, a rear side 28, and opposing left and right sides 30, 32, respectively. The overcap 10 is adapted to be retained on an upper end 34 of an aerosol container 36, which is shown in FIG. 12 and will be described in further detail below. The overcap 10 provides a user the ability to automatically or manually dispense fluid from the container 36. It is intended that the overcap 10 be used in many diverse environments, such as a home, a business, a vehicle, outdoors, etc.

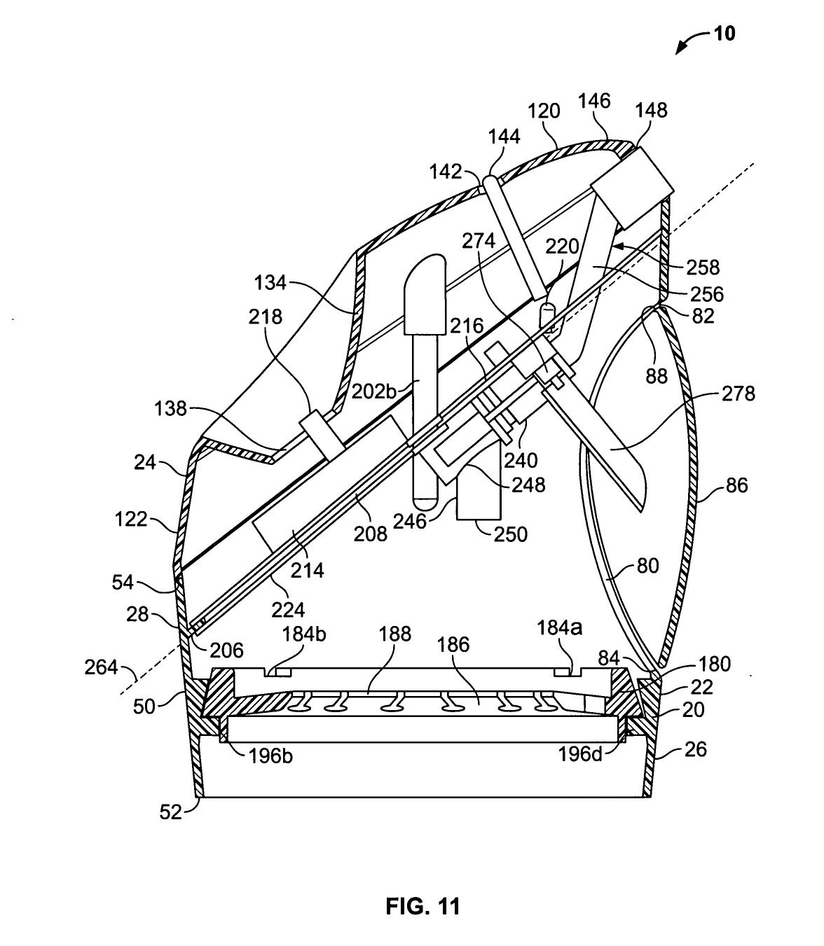

The body portion 22 includes a sidewall 50 and is adapted to be gripped by a user's hand. The sidewall 50 extends from a lower end 52 of the body portion 22 to an upper end 54 thereof. The sidewall 50 tapers outwardly about a longitudinal axis 56 of the overcap 10 so that a cross-sectional diameter of the lower end 52 is smaller than a cross-sectional diameter of the upper end 54. The front side 36 of the sidewall 50 includes an oval-shaped recess 80. The recess 80 includes a major diameter that extends between first and second ends 82, 84 (see FIG. 11), which are adjacent the upper and lower ends 54, 52, respectively, of the sidewall 50. An oval-shaped flange 86 that is sized to be substantially co-extensive with the recess 80 is provided therein. The flange 86 is connected to the sidewall 50 by a resilient living hinge 88 adjacent the first end 82 of the recess 80. The thickness of the living hinge 88 is less than the thickness of the remaining sides of the sidewall 50 to impart flexibility and resiliency to the living hinge 88.

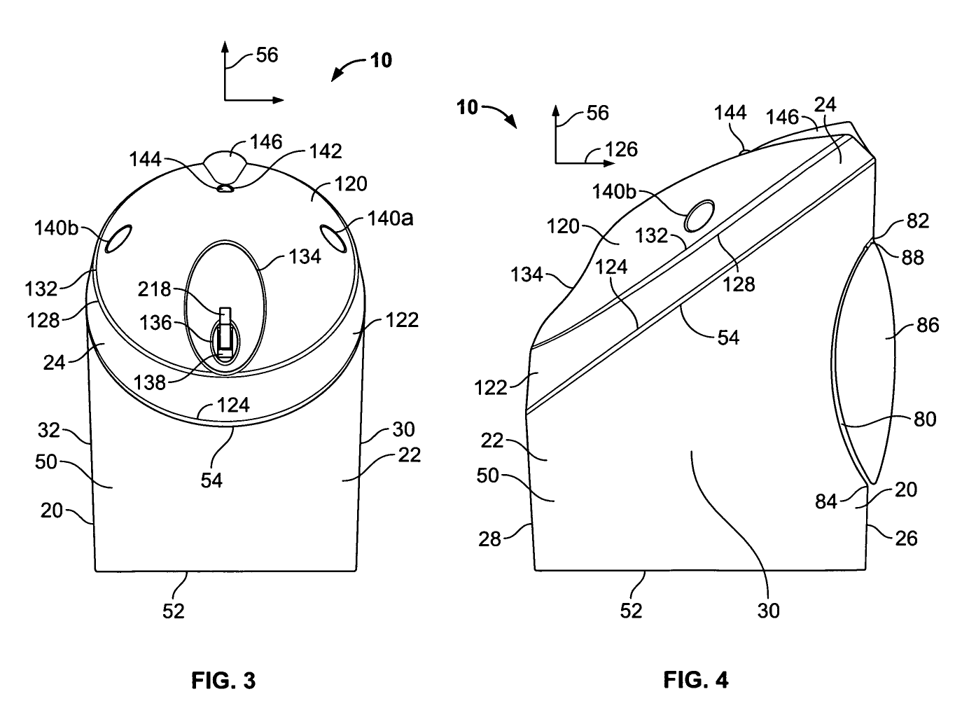

The cap portion 24 comprises a shell 120 and an annular rim 122. A lower end 124 of the annular rim 122 is disposed on the upper end 54 of the sidewall 50 and truncates same at approximately a 45 degree angle relative to a transverse axis 126 of the overcap 10. The shell 120 extends from an upper end 128 of the rim 122 and has a generally convex surface. The convex surface of the shell 120 is bounded by an elliptical shaped edge 132 that extends circumferentially around the upper end 128 of the annular rim 122. As shown in FIGS. 3-6, 8, and 11, a curved cavity 134 is disposed within the shell 120 adjacent the rear side 28 of the overcap 10. The curved cavity 134 includes a flat bottom 136 with a rectangular slot 138 disposed therein. Two holes 140a, 140b are disposed on opposing sides of the transverse axis 126 adjacent the left and right sides 30, 32, respectively, of the overcap 10. An aperture 142 is also provided between the cavity 134 and the front side 26 of the overcap 10. A light transmissive rod 144 is held within the aperture 142 by an interference fit (see FIG. 11). A curved ridge 146 extends from the aperture 142 toward the front side 26 of the overcap 10. An opening 148 is provided within portions of the ridge 146, the annular rim 122, and the sidewall 50 adjacent the front side 26 of the overcap 10.

The overcap 10 discharges fluid from the container 36 upon the occurrence of a particular condition. The condition could be the manual actuation of the overcap 10 by the flange 86 or the automatic actuation of the overcap 10 in response to a signal from a timer or a sensor. The fluid discharged may be a fragrance or insecticide disposed within a carrier liquid, a deodorizing liquid, or the like. The fluid may also comprise other actives, such as sanitizers, air fresheners, odor eliminators, mold or mildew inhibitors, insect repellents, and the like, or that have aromatherapeutic properties. The fluid alternatively comprises any fluid known to those skilled in the art that can be dispensed from a container. The overcap 10 is therefore adapted to dispense any number of different fluid formulations.

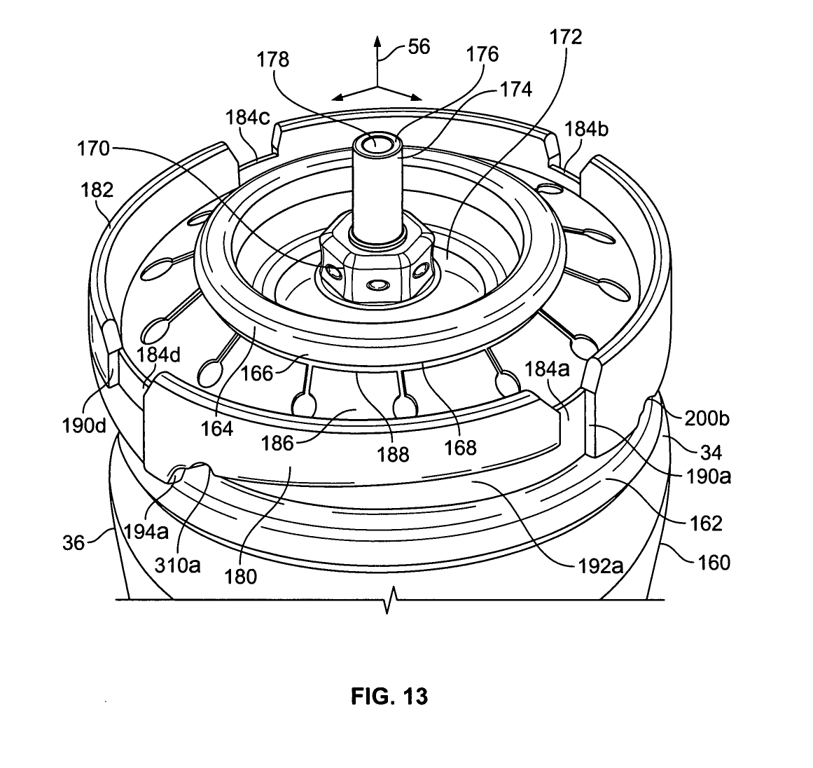

Turning to FIG. 13, the aerosol container 36 comprises a body 160 having a dome shaped wall section 162 crimped to the upper end 34 of the container 36. An opening (not shown) is provided within an upper end of the wall section 162 and is obstructed by a mounting cup 164, which is similarly crimped to the wall section 162. The mounting cup 164 is generally cylindrical in shape and includes an outer wall 166 that extends circumferentially therearound. An undercut 168 is provided between portions of the container 36 and the area of crimping of the mounting cup 164. A pedestal 170 extends upwardly from a recessed central portion of a base 172 of the mounting cup 164. A valve assembly (not shown) provided in an interior of the container 36 includes a valve stem 174, a valve body (not shown), and a valve spring (not shown). The valve stem 174 extends through the pedestal 170, wherein a distal end 176 extends upwardly away from the pedestal 170 and a proximal end is disposed within the valve body. The valve assembly is opened by depressing the valve stem 174, wherein a pressure differential between the container interior and the atmosphere forces the contents of the container 36 out through an orifice 178 of the valve stem 174. While the present disclosure describes the applicants' invention with respect to the aerosol container 36, the present invention may be practiced with any type of aerosol container known to those skilled in the art. Further, the contents of the container 36 may be discharged in a continuous or metered dose. Still further, the discharging of the contents of the container 36 may be effected in any number of ways, e.g., a discharge may comprise a partial metered dose or multiple consecutive discharges.

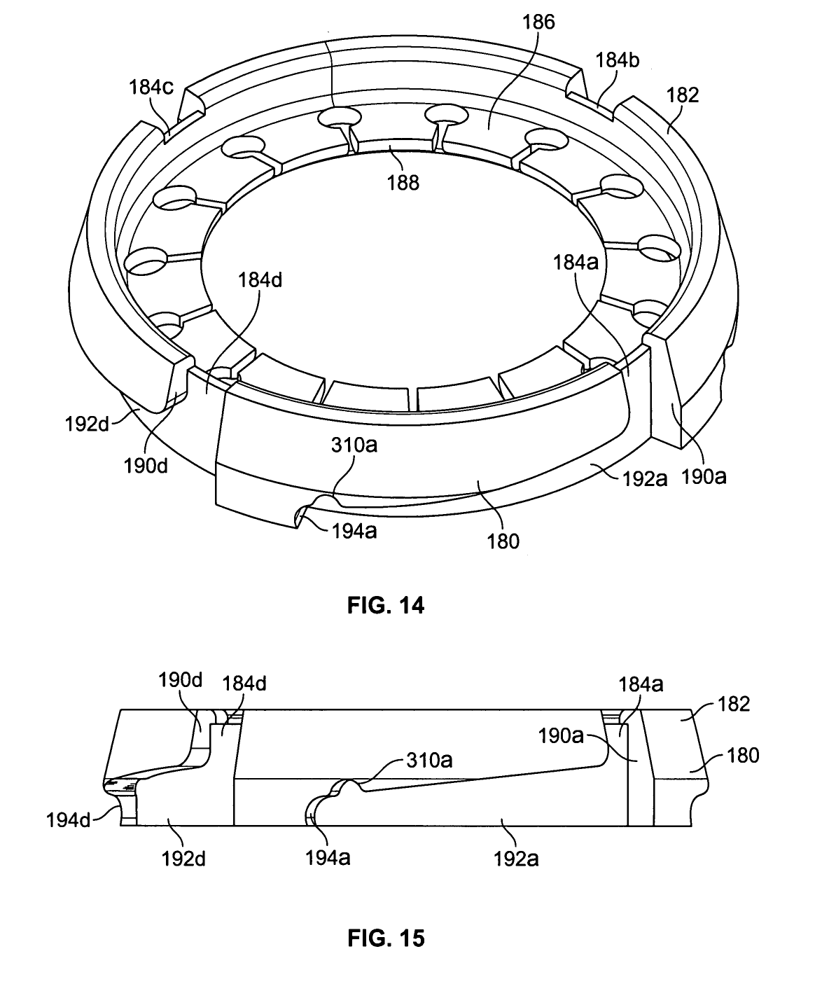

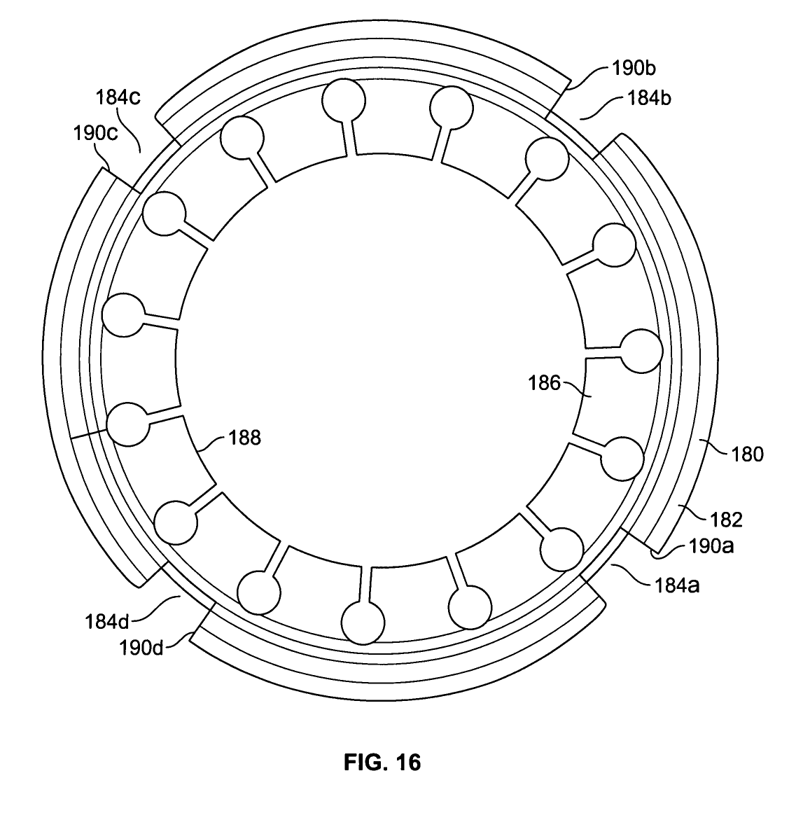

As noted above, the overcap 10 is adapted to be retained on the upper end 34 of the container 36. Turning to FIGS. 11 and 13-17 one such retaining structure is shown to comprise an annular bracket 180. The bracket 180 includes a circumferential sidewall 182 interrupted by equidistantly spaced bayonet slots 184a, 184b, 184c, 184d. The bracket 180 also includes a plurality of resilient flanges 186 that extend radially inwardly from a medial portion of the sidewall 182 toward the mounting cup 164. Distal ends 188 of the plurality of flanges 186 are sized to bend about the outer wall 166 of the mounting cup 164 when the bracket 180 is pressed downwardly onto the upper end 34 of the container 36. Sufficient downward force causes the distal ends 188 of the plurality of flanges 186 to snap into the undercut 168, thereby retaining the bracket 180 on the container 36. The bayonet slots 184a, 184b, 184c, 184d include grooves 190a, 190b, 190c, 190d, respectively, that extend through an outer surface of the sidewall 182. Further, channels 192a, 192b, 192c, 192d, extend circumferentially about a lower portion of the sidewall 182 from the grooves 190a, 190b, 190c, 190d, respectively. A depth of the channels 192a-d becomes uniformly shallower as the channels 192a-d extend from the grooves 190a-d to distal ends 194a, 194b, 194c, 194d of the channels 192a, 192b, 192c, 192d, respectively.

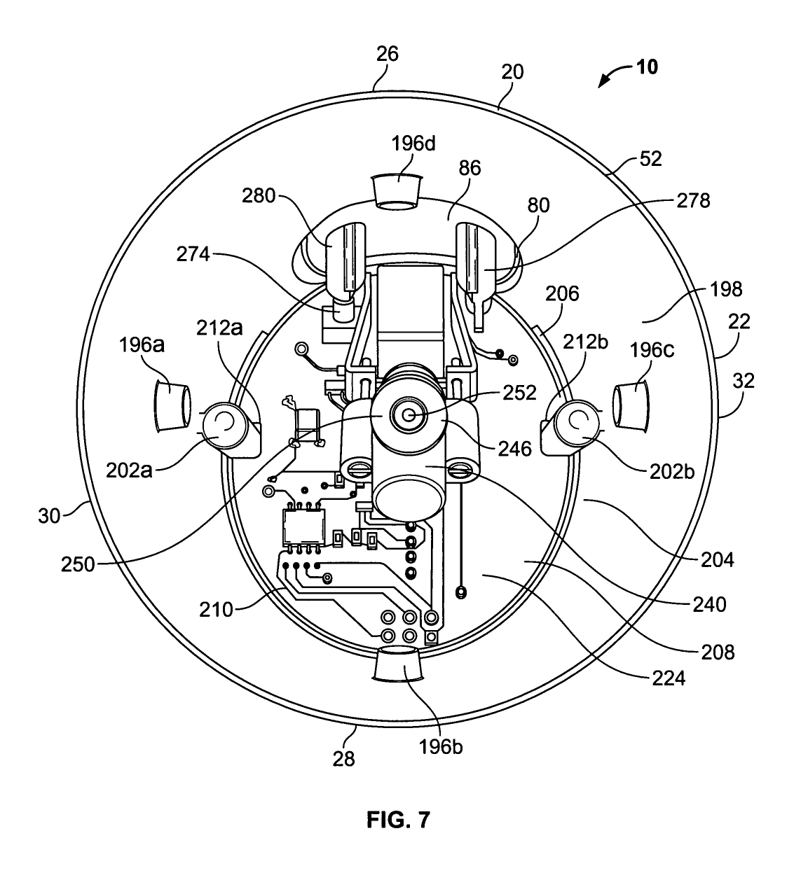

To operably place the overcap 10 onto the container 36, a user must align lugs 196a, 196b, 196c, 196d, which are shown in FIGS. 7 and 11, with the bayonet slots 184a, 184b, 184c, 184d, respectively. The lugs 196a-d are equidistantly spaced apart on an inner surface 198 of the body portion 22 and are sized to be received within the grooves 190a-d of the bayonet slots 184a-d. Upon receipt of the lugs 196a-d within the grooves 190a-d, a user rotates the overcap 10 in a clockwise manner to slide the lugs 196a-d into the channels 192a-d. Continued rotational movement of the overcap 10 forces the lugs 196a-d to impinge against the walls defining the channels 192a-d and force them downwardly as the depth of the channels 192a-d becomes shallower. Forcing the lugs 196a-d downwardly also forces the overcap 10 itself to be pulled downwardly toward the container 36. The lugs 196a-d are thereafter releaseably locked in place at the distal ends 194a-d of the channels 192a-d, which will be described in greater detail hereinafter, to retain the overcap 10 onto the container 36 in an operable position.

It is also contemplated that modifications may be made to the bracket 180. For example, a fewer or greater number of flanges may be provided to interact with surfaces of a container. The flanges of the bracket may be resilient or rigid depending upon the contour of the outer surface of the container. Further, the overcap may be operably placed onto the bracket in a fixed or removable manner. Still further, the overcap may be operably placed on the container by other means besides those described above. In one embodiment, the overcap is threaded onto the bracket. In a different embodiment, one or more tabs are provided on the overcap or bracket for interaction with one or more recesses on the bracket or overcap, respectively. In another embodiment, portions of the overcap are inserted into the bracket and rotated to secure the portions of the overcap within a channel or between other locking surfaces of the bracket. It is also contemplated that any of these embodiments may be modified to include a structure for locking with the overcap on an interior, medial portion, or exterior of the bracket.

FIGS. 7, 8, and 11 illustrate that a pair of posts 202a, 202b are disposed on left and rights sides, respectively, of the inner surface 198 of the sidewall 50. Further, a ridge 206 extends circumferentially about a portion of the inner surface 198, which is adapted to support a platform 208. The platform 208 of the present embodiment, which is shown in FIGS. 7-11, is a printed circuit board having a control circuit 210 disposed thereon. In other embodiments, the control circuit 210 is a separate component from the platform 208 and is mounted on the platform 208 or otherwise retained within the interior of the overcap 10. The platform 208 is provided with notches 212a, 212b on opposing sides thereof corresponding to the posts 202a, 202b, respectively. When the platform 208 is secured within the overcap 10, the platform 208 is substantially parallel to the annular rim 122. A user selectable switch assembly 214 is disposed on an upper surface 216 of the platform 208 proximate the rear side 28 of the overcap 10. A finger 218 extends upwardly from the switch assembly 214. Further, a light emitting diode (LED) 220 is disposed on the platform 208 between the switch assembly 214 and a third notch 222. When the cap portion 24 is attached to the body portion 22, the posts 202a, 202b within the overcap 10 are aligned with the holes 140a, 140b of the convex surface of the shell 120. Screws (not shown) extend through the holes 140a, 140b and into the posts 202a, 202b, respectively, to attach the cap portion 24 to the body portion 22. When the cap portion 24 is attached to the body portion 22 the finger 218 extends through the slot 136, thereby allowing the user to select different operating modes for the circuit 210, which will be discussed in greater detail below.

FIGS. 7 and 9-11 depict a lower surface 224 of the platform 208, which includes a valve assembly 240 mounted thereon. The valve assembly 240 of the present embodiment comprises a two-way solenoid valve. The two-way solenoid valve of the present embodiment is a Tri-Tech Miniature Two Way Valve manufactured by Tri-Tech, LLC, of Mishawaka, Ind. However, other two-way solenoid valves known to those skilled in the art are also contemplated as being within the scope of the present disclosure. While a solenoid valve is presently described in connection with the disclosed embodiments, it is also contemplated that other mechanical and/or electrically controlled valve mechanisms known to those skilled in the art may be used.

A conduit 246 includes first and second ends 248, 250, respectively, and is in fluid communication with the solenoid valve assembly 240. The second end 250 is adapted to be disposed on the distal end 176 of the valve stem 174. More particularly, when the overcap 10 is first placed on the container 36 in the manner discussed above, the lugs 196a-d are aligned with the bayonet slots 184a-d. This alignment procedure also ensures that the valve stem 174 is aligned with the conduit 246. As the user rotates the overcap 10 and forces the lugs 196a-d into the channels 192a-d, the overcap 10 is pulled downwardly a sufficient distance to cause the second end 250 of the conduit 246 to impinge against the distal end 176 of the valve stem 174 and open the valve assembly of the container 36. When the distal end 176 of the valve stem 174 is pressed against the second end 250 of the conduit 246, a fluid path is provided between the discharge orifice 178 (see FIG. 13) of the valve stem 174 and a channel 252 (see FIG. 7) of the conduit 246. The spacing between the valve stem 174 and the conduit 246 is controlled to ensure full and/or partial depression of the valve stem 174 when the overcap 10 is placed onto the container 36 and into an operable position. Further, the spacing and sizing of the valve stem 174 and the conduit 246 is appropriately controlled to ensure fluid communication between the container 36 and the conduit 246 while preventing or substantially preventing fluid leakage between the point of contact of the distal end 176 of the valve stem 174 and the second end 250 of the conduit 246.

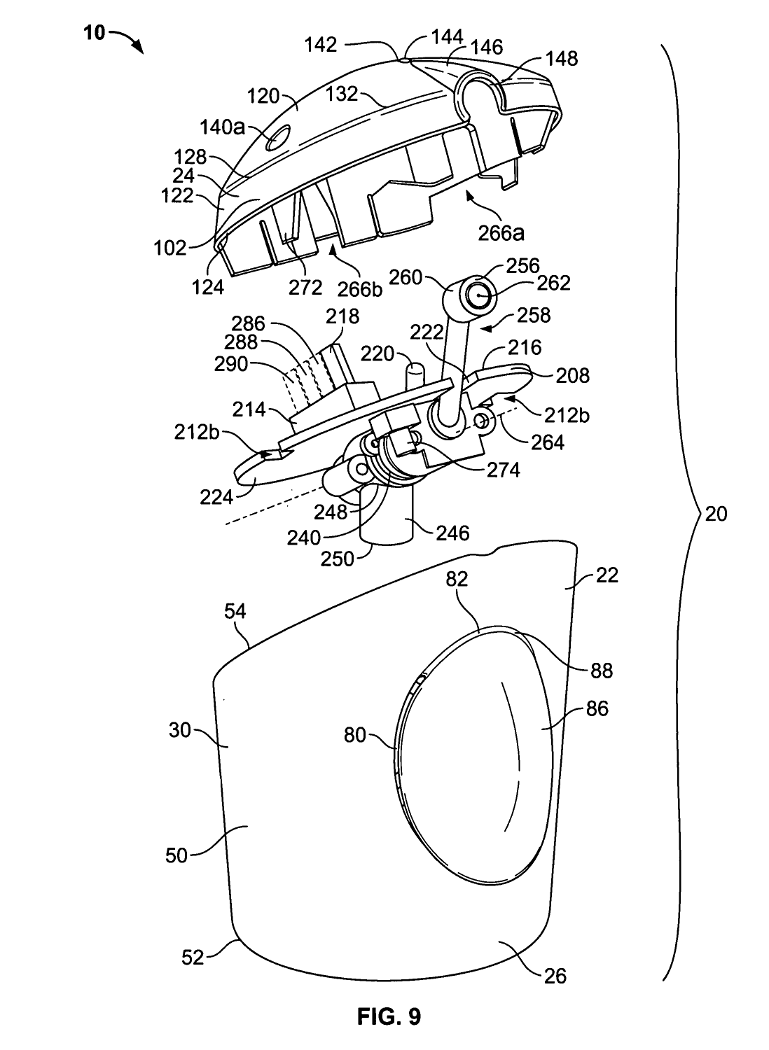

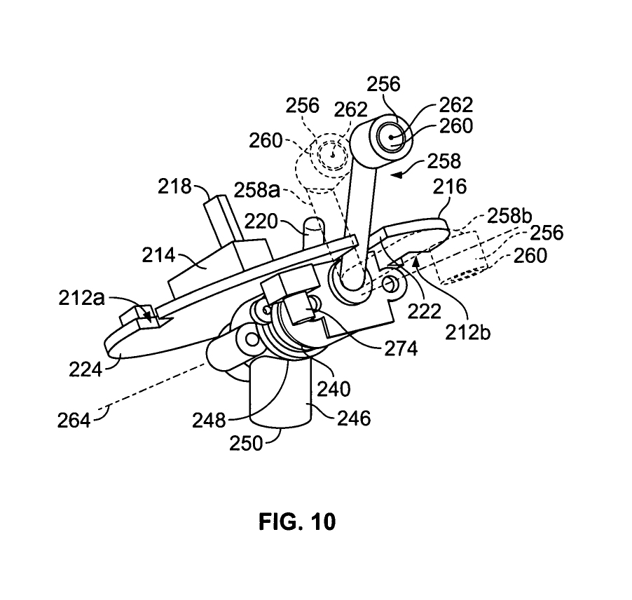

Referring again to FIGS. 7 and 9-11, the solenoid valve assembly 240 is in fluid communication with the first end 248 of the conduit 246. As noted above, when the overcap 10 is placed on the container 36 the valve assembly thereof is kept in an open state. Therefore, fluid is discharged through the valve stem 174 and into the conduit 246. The solenoid valve assembly 240 receives fluid from the conduit 246 and regulates the emission of the fluid therefrom by way of the control circuit 210. When the solenoid valve assembly 240 receives a signal from one or more of an elapsed timer, sensory input, or manual actuation of a trigger such as the flange 86, the solenoid valve assembly 240 is opened for a predetermined period of time. Fluid discharged from the solenoid valve assembly 240 is emitted through a nozzle 256. In the present embodiment, the nozzle 256 is disposed in a first position 258 (see FIGS. 9-11) at an angle relative to the longitudinal axis 56 of the container 36. Further, a discharge end 260 of the nozzle 256 is provided to direct the fluid out of the overcap 10 and into the atmosphere. In the present embodiment, the discharge end 260 includes a discharge orifice 262 and is retained within the opening 148 in the front side 36 of the overcap 10. Further, in the present embodiment, the discharge end 260 of the nozzle 256 is substantially parallel to a longitudinal axis 264 of the solenoid valve assembly 240. It is also contemplated that the nozzle 256 and/or the discharge end 260 may be oriented at any angle relative to the longitudinal axis 56, the transverse axis 126, the longitudinal axis 264, or any other axis of the overcap 10 or the solenoid valve assembly 240, of which the first, second, and third positions 258, 258a, 258b, respectively, shown in FIG. 10 are three examples.

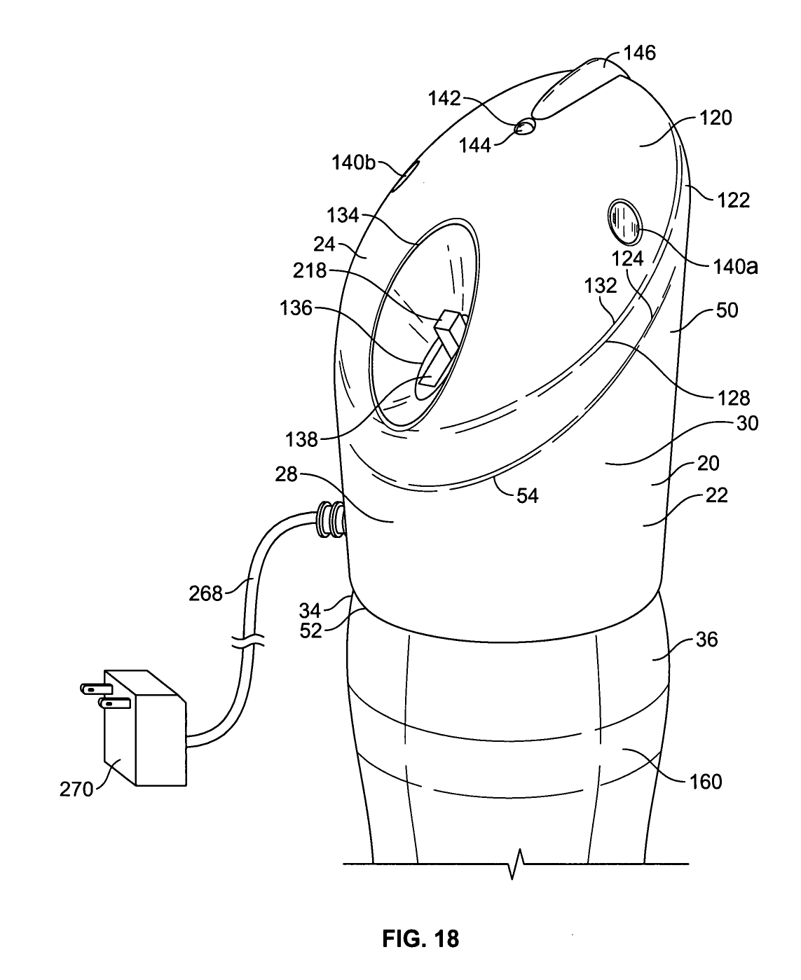

Turning to FIG. 9, first and second compartments 266a, 266b are provided on an inside surface of the cap portion 24. Both of the compartments 266a, 266b include positive and negative battery terminals therein (not shown). Further, each of the compartments 266a, 266b is adapted to fittingly receive two AA sized batteries therein. In an alternative embodiment, such as shown in FIG. 18, the AA batteries are replaced by an A.C power adapter 268 having an appropriate power transformer and A.C./D.C. converter 270 as known to those skilled in the art. In a different embodiment, the AA batteries are replaced by a rechargeable Nickel-Cadmium battery pack that has an electrical lead for connecting the battery pack to an A.C. power outlet. It is further contemplated that the overcaps described herein may be activated without a power source, i.e., interior portions of the flange 86 may be adapted to physically open the solenoid valve assembly to dispense fluid either continuously or intermittently when the flange 86 is depressed by a user. FIG. 9 also illustrates that the cap portion 24 includes a plurality of resilient members 272, which depend downwardly beyond the lower end 124 of the annular rim 122. The plurality of resilient members 272 are adapted to lockingly engage with an inside surface of the upper end 54 of the sidewall 50.

FIGS. 7 and 9-11 illustrate that a manual switch 274 is also provided on the lower surface 224 of the platform 208. The switch 274 (see FIG. 7) is positioned in alignment with an actuating arm 276 that extends from an inner surface of the flange 86. When the flange 86 is depressed by a user, the actuating arm 276 is pivoted about the living hinge 88 to impinge against the switch 274. When a user releases the flange 86, the actuating arm 276 rotates along with the flange 86 back into a pre-operative position where the arm 276 no longer impacts the switch 274 or, alternatively, no longer impacts the switch 274 to a degree sufficient to activate the overcap 10. A second arm 278 is also provided on the inner surface of the flange 86, which is adapted to stabilize the flange 86 when in a depressed or operative position. Utilization of a living hinge provides the user an easy means to manually actuate the overcap 10.

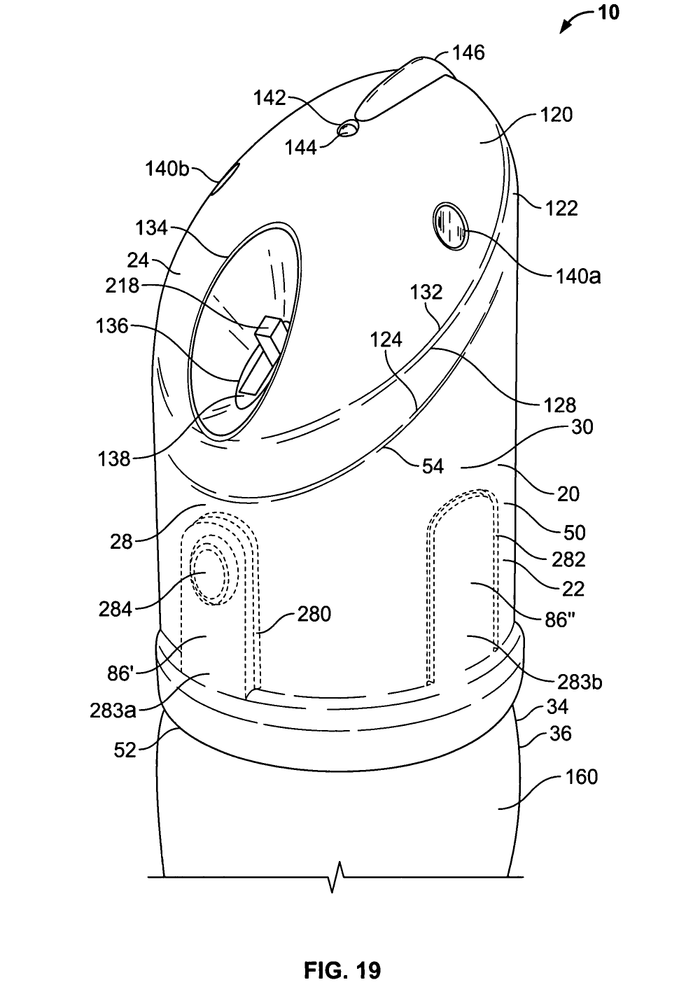

It is contemplated that other buttons and/or triggers may be used with the present embodiments that are similar in function to the flange 86, i.e., a button or trigger that includes a living hinge. FIG. 19 illustrates how the overcap 10 may be modified to include various buttons and/or triggers with different shapes and/or orientations. In the present embodiment, a stepped annular portion is provided adjacent the lower end 52 of the body portion 22. One example of a generally rectangular trigger 86′ extends upwardly from the stepped portion adjacent a recess 280 in the rear side 28 of the body portion 22. In another example, a generally rectangular button 86″ extends upwardly within a recess 282 in the left side 30 of the overcap 10 in a manner that is coextensive with the body portion 22. The trigger 86′ and the button 86″ of the present embodiments are adapted to flex about lower ends 283a, 283b, respectively, thereof, which may or may not be provided with weakened or thinned sections to assist in the flexure. The trigger 86′ and the button 86″ are illustrative of the various shapes and positions that triggers and/or buttons may have. Indeed, a button or actuator may be positioned anywhere about the overcap 10. Further, a button or trigger may also include surfaces adapted to assist in positioning a user's finger over a specified area of the button or trigger to assist in actuating same. For example, the trigger 86′ includes an outwardly extending portion 284 that has a concave depression adapted to receive a user's finger. In all of the embodiments, an inner surface (not shown) of the trigger 86′ or the button 86″ is adapted to impact and activate a switch (not shown) for the manual operation of the overcap 10. The activation of the switch may be made either directly or through other means such as an actuating arm (not shown) that may be similar to the actuating arm 276 described above. One advantage to using a trigger or button with a living hinge is that users may impart an actuating force over a greater surface area than typically found with conventional buttons. Further, the housings of the present embodiments may be fashioned to allow a user to easily grip the body portion 22 and to position one or more of the user's fingers adjacent the button or trigger. Still further, the trigger or button may be shaped or sized in any number of ways to provide certain aesthetic impressions.

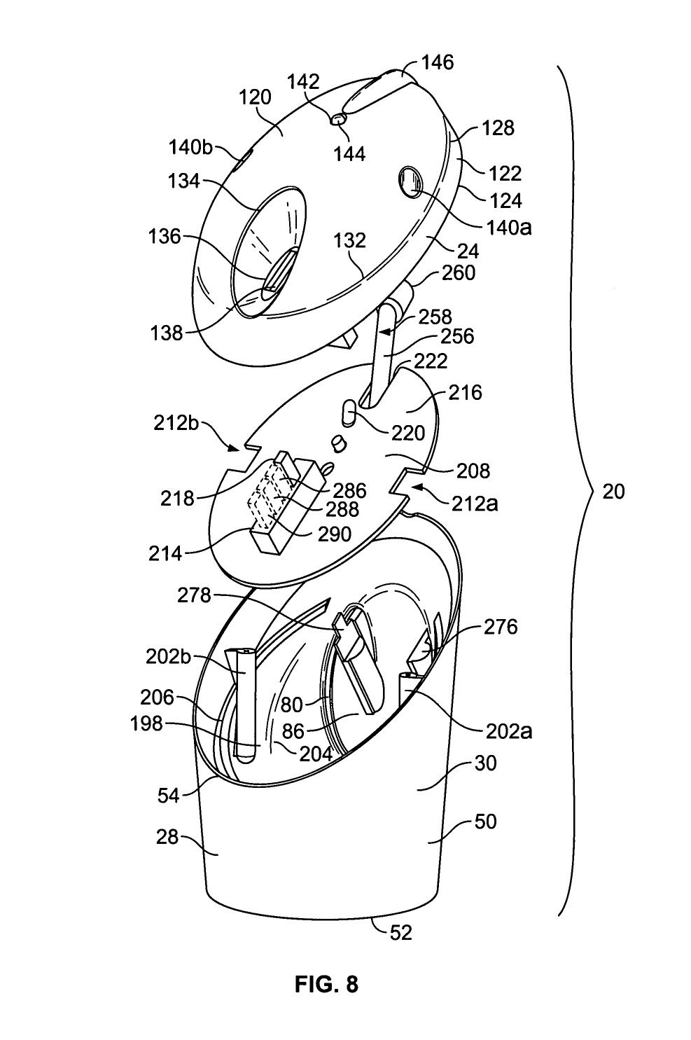

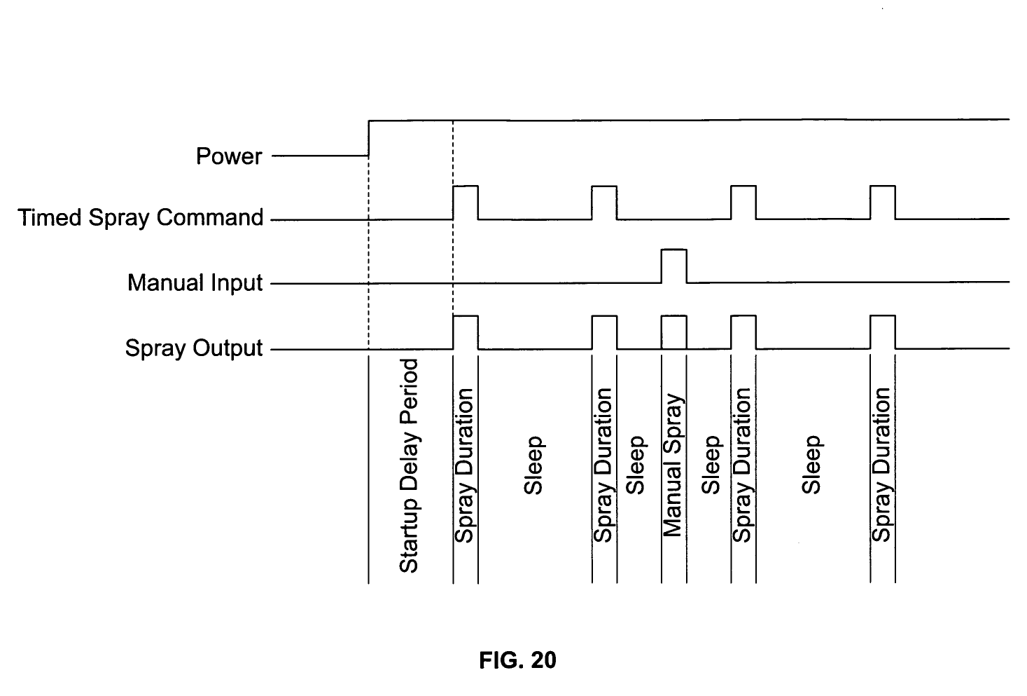

FIG. 20 depicts a timing diagram of the present embodiment that illustrates the operation of the overcap 10 during an in use condition. Initially, the overcap 10 is energized by moving the finger 218 of the switch assembly 214 from an “OFF” position to one of three operating modes 286, 288, 290 (see FIGS. 8 and 9), whereupon the overcap 10 enters a startup delay period. Each of the three operating modes 286, 288, 290 corresponds to a predetermined sleep period interval between consecutive spraying periods. For example, the first operating mode 286 can correspond to a five minute sleep period, the second operating mode 288 can correspond to a fifteen minute sleep period, and the third operating mode 290 can correspond to a thirty minute sleep period. For the present example, we shall assume the first operating mode 286 has been chosen. Upon completion of the startup delay period, the solenoid valve assembly 240 is directed to discharge fluid from the overcap 10 during a first spraying period. The startup delay period is preferably about three seconds long, and the spraying period is typically about 170 milliseconds long. Upon completion of the first spraying period, the overcap 10 enters a first sleep period that lasts 5 minutes. Upon expiration of the first sleep period the solenoid valve assembly 240 is actuated to discharge fluid during a second spraying period. Thereafter, the overcap 10 enters a second sleep period that lasts for 5 minutes. In the present example, the second sleep period is interrupted by the manual actuation of the overcap 10, whereupon fluid is dispensed during a third spraying period. Automatic operation thereafter continues with alternating sleep and spraying periods. At any time during a sleep period, the user can manually actuate the overcap 10 for a selectable or fixed period of time by depressing the flange 86. Upon termination of the manual spraying operation, the overcap 10 completes the pending sleep period. Thereafter, a spraying operation is undertaken. In an alternative embodiment, a new sleep period is initiated in response to the termination of a manual spraying operation.

In another embodiment, the switch assembly 214 may be replaced or supplemented by a photocell sensor. The photocell sensor is used to detect changes in light levels, which in some instances is used to detect motion of an object through a sensory path. During use the photocell sensor collects ambient light and allows the circuit to detect any changes in the intensity thereof. Filtering of the photocell output is undertaken by the control circuit 210. If the control circuit 210 determines that a threshold light condition has been reached, e.g., a predetermined level of change in light intensity, the circuit 210 develops a signal to activate the solenoid valve assembly 240. For example, if the overcap 10 is placed in a lit bathroom, a person walking past the sensor may block a sufficient amount of ambient light from reaching the sensor to cause the control circuit 210 to activate the solenoid valve assembly 240 and discharge a fluid. Other motion detectors known to those of skill in the art may also be utilized e.g., a passive infrared or pyro-electric motion sensor, an infrared reflective motion sensor, an ultrasonic motion sensor, or a radar or microwave radio motion sensor.

It is also envisioned that the switch assembly 214 may be replaced or supplemented with a vibration sensor, an odor sensor, a heat sensor, or any other sensor known to those skilled in the art. Alternatively, more than one sensor may be provided in the overcap 10 in lieu of the switch assembly 214 or in combination with same. It is anticipated that one skilled in the art may provide any type of sensor either alone or in combination with the switch assembly 214 and/or other sensors to meet the needs of a user. In one particular embodiment, the switch assembly 214 and a sensor are provided in the same overcap. In such an embodiment, a user may choose to use the timer-based switch assembly 214 to automatically operate the solenoid valve assembly 240 of the overcap 10, or the user may choose to use the sensor to detect a given event prior to activating the overcap 10. Alternatively, the overcap 10 may operate in a timer and sensor based mode of operation concurrently.

The LED 220 illuminates the light transmissive rod 144 when the overcap 10 is in an operative state. The LED 220 blinks intermittently once every fifteen seconds during the sleep period. Depending on the selected operating mode, the blinking frequency of the LED 220 begins to increase as a spraying period becomes imminent. The more frequent illumination of the LED 220 serves as a visual indication that the overcap 10 is about to discharge fluid contents into the atmosphere.

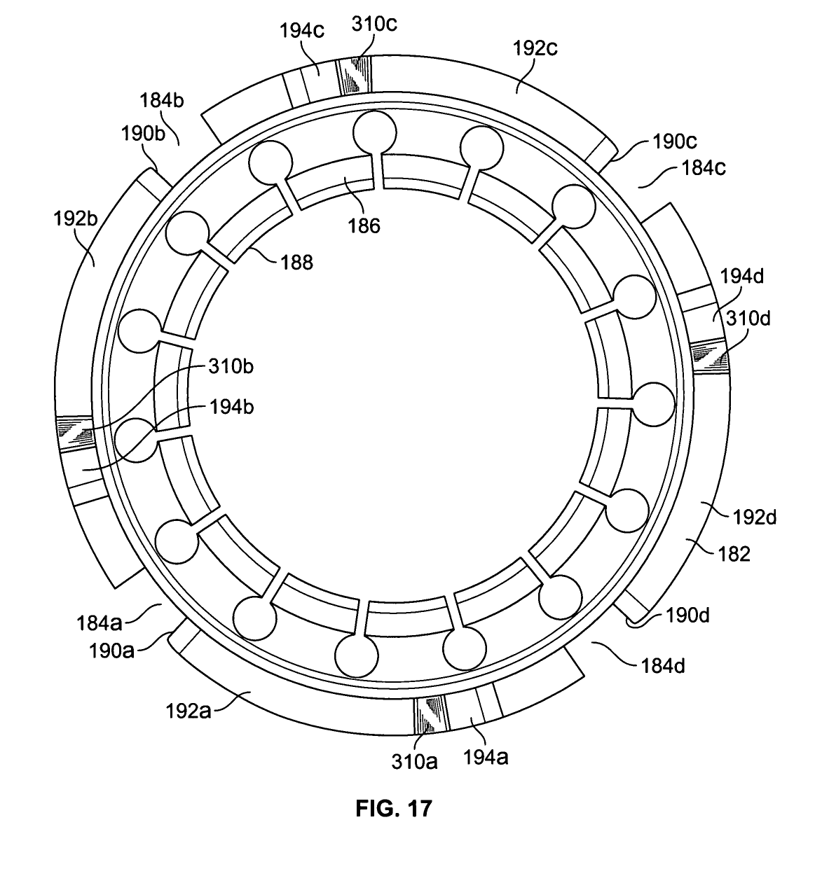

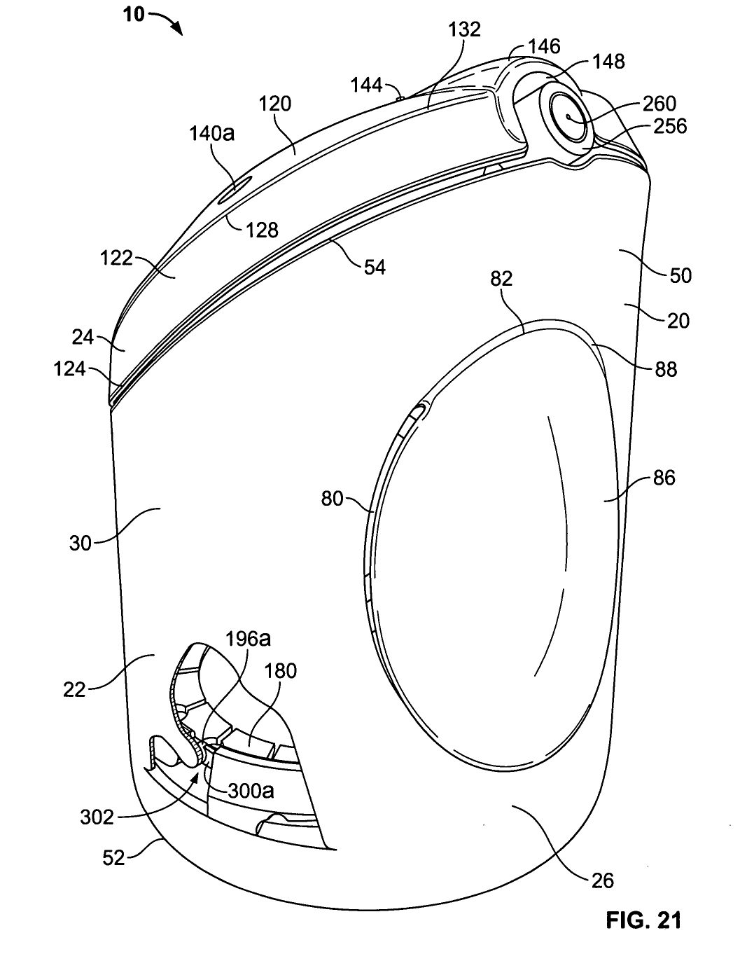

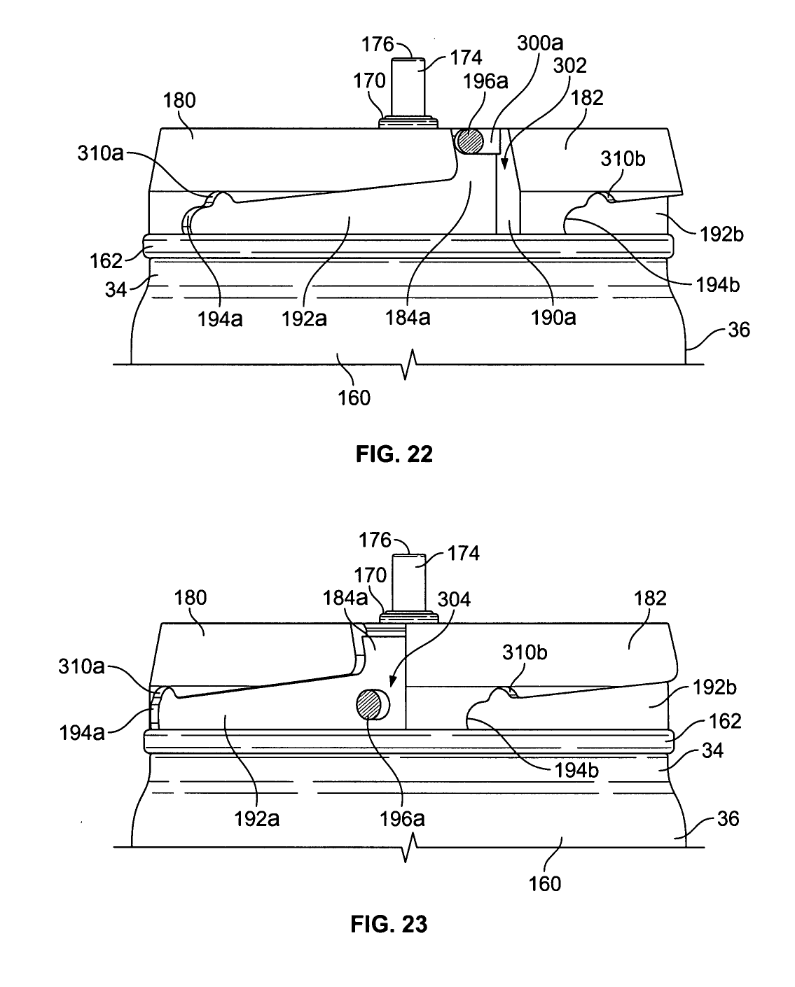

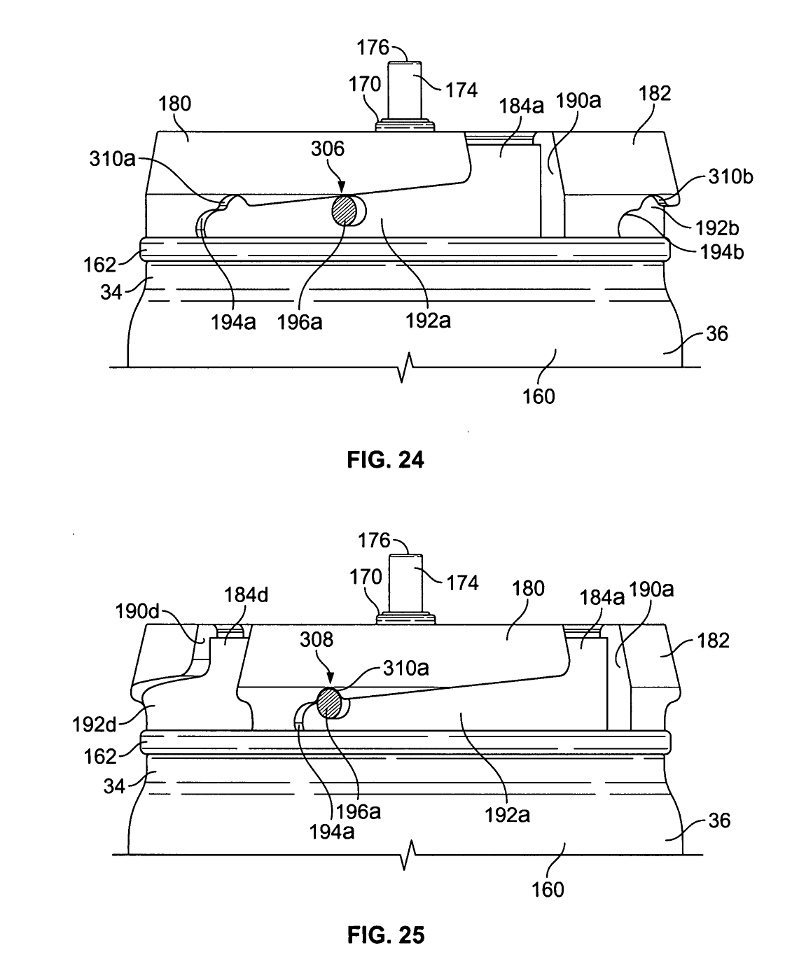

FIGS. 21-25 illustrate a second manner in which the overcap 10 is operably placed on the container 36. In the present embodiment, the lugs 196a-d are retained within the bayonet slots 184a-d by corresponding frangible tabs. To illustrate how the overcap 10 is placed in an operative position, reference will be had to the lug 196a and how same is transitioned from a pre-operative position to a post-operative position. FIG. 21 illustrates how the lug 196a extends inwardly from the inner surface 198 of the body portion 22 and is connected to the bracket 180 by a frangible tab 300a in a first or pre-operative position 302. FIG. 22 more clearly illustrates the positioning of the lug 196a in this pre-operative position 302 by the removal of portions of the overcap 10. When a user wishes to place the overcap 10 in an operative position, the user forces the overcap 10 downwardly about the longitudinal axis 56 toward the container 36. Forcing the overcap 10 downwardly causes the frangible tab 300a to break and for the lug 196a to be forced downwardly within the groove 190a and into a second position 304, such as shown in FIG. 23. The user thereafter rotates the overcap 10 in a clockwise direction to force the lug 196a to pass through the channel 192a. FIG. 24 illustrates the lug 196a in a third position 306 within the channel 192a and interacting with the downwardly sloping walls that define the channel 192a. Continued rotational movement causes the lug 196a to force the overcap 10 downwardly with respect to the container 36 and into an operative position 308, such as illustrated in FIG. 25. The lug 196a is placed in the operative position 308 by causing the lug 196a to enter and be retained within a notch 310a. The lug 196a is retained within the notch 310a by the forces exerted by the valve spring of the valve assembly, i.e., as the overcap 10 is forced downwardly onto the container 36 the distal end 176 of the valve stem 174 resistively interacts with the second end 250 of the conduit 246 to try to push the overcap 10 away from the container 36. Therefore, the force that was previously overcome during the downward and rotational movements illustrated in FIGS. 23 and 24 now forces the lug 196a upwardly within the channel 192a and into the notch 310a, thereby retaining the lug 196a in the notch 310a and the overcap 10 in the operative position 308. Likewise, the lugs 196b, 196c, 196d are placed in an operative position in a similar manner and include corresponding frangible portions and notches 310b, 310c, 310d, respectively (see FIG. 17). The presently described embodiments may also be particularly advantageous when it is desired to package and/or transport the overcap 10 in combination with the container 36 while preventing the inadvertent dispensing of fluid.

In any of the embodiments described herein, the bracket 180 may be affixed to a container prior to receipt by a user. Alternatively, a user may place the bracket 180 on the container. Further, the bracket 180 may or may not be affixed to an overcap by a frangible portion. The use of a bracket in combination with an overcap may allow the reuse of the overcap with a replacement container and/or assist in preventing the inadvertent use of a container that may not work with a specific overcap. Such combinations have been referred to as lock and key mechanisms and have numerous advantages known to those of skill in the art. For example, the inadvertent use of the overcap 10 with a non-specified container may damage the overcap 10 or the container, which may require the user to replace one or more of the container and the overcap 10. It is also contemplated that the various embodiments of the bracket 180 described herein may be used in connection with other overcaps that include vertical or tilt activated valve stems. It is also anticipated that the various embodiments of the bracket 180 described herein may be used in connection with other overcaps having different actuation mechanisms than a valve assembly in combination with a vertically activated valve stem kept in a continuously open or partially open state, e.g., the actuation mechanism could be a drive unit that comprises a solenoid, a bimetallic actuator, a piezo-linear motor, or an electro-responsive wire that is adapted to actuate a vertical or tilt-activated valve stem. For example, it is anticipated that the bracket 180 may be combined with any of the overcaps described in a U.S. Patent Application entitled Actuator Cap for a Spray Device, filed on May 10, 2007, with a docket number of J-4462, which is incorporated by reference herein in its entirety.

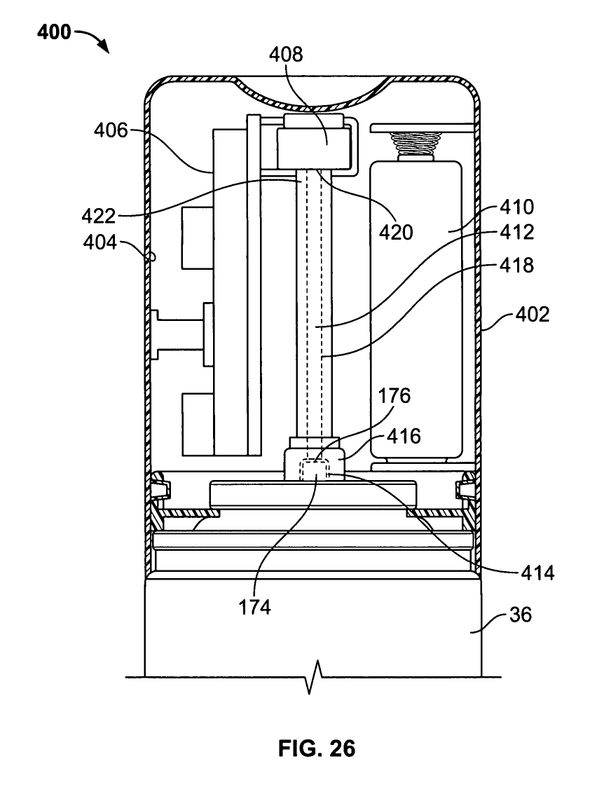

FIG. 26 depicts another embodiment of an overcap 400. The present embodiment comprises a cylindrical sidewall 402 having an inner surface 404. A control circuit 406 is mounted on the inner surface 404 and is in electrical communication with a two-way solenoid valve assembly 408. The solenoid valve assembly 408 and the control circuit 406 are also in electrical communication with two double AA batteries 410, which are similarly retained on the inner surface 404 of the overcap 400. A dispensing member 412, which in the present embodiment comprises a tubular element, is provided within an interior of the overcap 400 between the control circuit 406 and the batteries 410. When the overcap 400 is placed on the container 36, the distal end 176 of the valve stem 174 is seated within a circular opening 414 adjacent a bottom end 416 of the dispensing member 412. A bore 418 extends from the opening 414 and through a discharge orifice 420 in a top end 422 of the dispensing member 412. The solenoid valve assembly 408 is in fluid communication with the top end 422 of the dispensing member 412. When the overcap 400 is secured to the container 36 the dispensing member 412 interacts with the valve stem 174 to hold same in an open position. The emission of fluid from the overcap 400 is thereafter controlled by the circuit 406 and the solenoid valve assembly 408 in a similar manner as described above.

The embodiments described herein are illustrative of the different ways that a valve stem of an aerosol container may be held in an open condition to supply fluid to a two-way solenoid valve assembly. It will be apparent that numerous aspects of the embodiments described herein may be modified, such as the size and orientation of the nozzle 256 or the dispensing member 412. For example, the dispensing member 412 in the overcap 400 is substantially parallel to a longitudinal axis 56 of the overcap 10 and of the container 36, but may be easily modified to extend at a different angle relative to either of the axes. In a different example, the nozzle 256 and/or discharge end 260 may comprise a non-cylindrical shape and/or include varying cross-sectional dimensions throughout an entire or partial length thereof. Further, in a different example the discharge orifice 262 and/or the conduit or bore extending thereto may include a non-circular shape in whole or in part.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/We claim:

1. An actuator cap for a dispenser, comprising:
a housing having first and second ends, wherein the first end is adapted to be retained on an aerosol container having a valve stem;
a conduit having an inlet adapted to receive the valve stem of the container and hold the valve stem in an actuated position to open a valve assembly within the container; and
a solenoid valve in fluid communication with the conduit and a discharge orifice, wherein the solenoid valve is transitioned from a closed state to an open state by a signal generated by a controller to provide a fluid path between the conduit and the discharge orifice,
wherein the controller is adapted to generate the signal in response to the manual depression of a trigger retained on the housing by a living hinge.

2. The actuator cap of claim 1, wherein the housing is adapted to be removably attached to a container.

3. The actuator cap of claim 1, wherein the controller is further adapted to generate a signal in response to a timer.

4. The actuator cap of claim 1, wherein the controller is further adapted to generate a signal in response to a sensor.

5. The actuator cap of claim 4, wherein the sensor is a photocell sensor.

6. The actuator cap of claim 1, wherein the trigger includes an actuator arm.

7. The actuator cap of claim 6, wherein the actuator arm is adapted to contact a switch in an operative position to generate the signal.

8. An overcap for a dispenser, comprising:
a housing having a bottom end and a top end, wherein the bottom end is retained on an aerosol container having a valve stem;
a conduit having first and second ends, wherein portions of the conduit defining the second end hold the valve stem in a depressed and open position, and
wherein the second end is in fluid communication with a discharge orifice of the valve stem; and
a solenoid valve in fluid communication with the first end of the conduit and a discharge orifice, wherein the solenoid valve is transitioned from a closed state to an open state by a signal generated by a controller,
wherein the controller is adapted to generate the signal in response to the manual depression of a flange retained on the housing by a living hinge.

9. The overcap of claim 8, wherein the conduit retains the valve stem in a fully open position.

10. The overcap of claim 8, wherein the conduit retains the valve stem in a partially open position.

11. The overcap of claim 8, wherein the valve stem is vertically actuable relative to a longitudinal axis of the container.

12. The actuator cap of claim 8, wherein the controller is further adapted to generate a signal in response to a timer.

13. The actuator cap of claim 8, wherein the controller is further adapted to generate a signal in response to a sensor.

14. The actuator cap of claim 13, wherein the sensor is a photocell sensor.

15. A retention mechanism for a dispenser, comprising:
an annular bracket having a plurality of interiorly extending flanges adapted to hold the bracket on an aerosol container having a valve stem,
wherein the bracket is further adapted to releasably engage an overcap and align an actuation mechanism within an interior of the overcap with the valve stem.

16. The retention mechanism of claim 15, wherein the overcap includes a conduit having an inlet adapted to receive a valve stem and hold same in an actuated position to open a valve assembly within a container when the overcap is engaged with the annular bracket and when the annular bracket is disposed on the container.

17. The retention mechanism of claim 16, wherein the actuation mechanism of the overcap is a solenoid valve in fluid communication with the conduit and a discharge orifice, wherein the solenoid valve is transitioned from a closed state to an open state by a signal generated by a controller to provide a fluid path between the conduit and the discharge orifice.

18. The retention mechanism of claim 15, wherein the bracket includes means for releasably engaging the overcap.

19. The retention mechanism of claim 15, wherein at least one lug is provided on an inner wall of the overcap in communication with at least one bayonet slot in the bracket.

20. The retention mechanism of claim 19, wherein the at least one lug is retained within the bayonet slot by a frangible portion.
